(19) United States
(12) Patent Application Publication
(10) Pub. No.: US 2013/0087511 A1
(43) Pub. Date: Apr. 11, 2013

(54) METHOD AND APPARATUS FOR REDUCING VOCS RELEASED DURING FRACKING OPERATIONS

(71) Applicants: Richard Ledebuhr, Bath, MI (US); Michael H. Hetherington, Williamston, MI (US)

(72) Inventors: Richard Ledebuhr, Bath, MI (US); Michael H. Hetherington, Williamston, MI (US)

(21) Appl. No.: 13/647,029

(22) Filed: Oct. 8, 2012

Related U.S. Application Data
(60) Provisional application No. 61/544,404, filed on Oct. 7, 2011.

(51) Int. Cl. C02F 1/20; B01D 17/02; C02F 1/68; B01D 19/00; C02F 1/40

(52) U.S. Cl. 210/750; 210/150; 210/151; 210/767

(57) ABSTRACT

A scrubbing system and method reduces volatile organic compound (VOC) vapors released during hydraulic fracturing. The water created by the process itself is used to help control the VOCs. During the collection process, the water and VOCs separate in a tank. A small amount of the water from below the separated VOCs is pumped to atomization equipment above the flowback liquid. In the preferred embodiment, rotary atomizers are used to create a mist of very fine droplets. Emulsifiers may be added to the water at the atomizer. The mist containing the emulsifiers is distributed throughout the space above the flowback water in the tank and on the liquid surface and walls of the tank. The mixing of the mist containing the emulsifiers and the VOC vapor allows the emulsifiers to capture the VOC vapor and return it to the liquid surface.

### REFERENCE TO RELATED APPLICATION

This application claims priority from U.S. Provisional Patent Application Ser. No. 61/544,404, filed Oct. 7, 2011, the entire content of which is incorporated herein by reference.

### FIELD OF THE INVENTION

This invention relates generally to hydraulic fracturing or “fracking” and, in particular, to minimizing the release of volatile organic compounds (VOCs) from collection tanks associated with such operations.

### BACKGROUND OF THE INVENTION

To improve the production of many gas and oil wells, hydraulic fracturing or fracking is used. Fracking involves the pressurized injection of special fluids into geologic formations, causing fractures in the formations, thereby inducing the release of oil or natural gas. During the fracking process, fracking fluids are injected into the well to initiate fractures. These fluids contain various solid materials such as sand that serve to prop the fractures open and varying types and amounts of chemical additives that adjust viscosity, prevent scale and serve other functions as the well is fluid is delivered.

Once the formation is fractured, fracking fluid pressure is reduced, reversing the direction of the fluid flow in the well toward the ground surface. Both fracking fluid and any naturally occurring substances, such as volatile organic compounds (VOCs), released from the underground formation are allowed to “flowback” to the ground surface where they are collected and further processed before releasing the environment.

The flowback water recovered from the hydraulic fracturing (fracking) process contains a considerable amount of volatile organic compounds (VOCs). Managing and reducing the release of these VOCs during the collection of the flowback water at the well site is a problem. To prevent damage to the environment, strict rules have been enacted to regulate the amount of released VOCs and other factors associated with handling the flowback water

To meet these requirements, the flow back water is placed into holding tanks at the well site before transportation to final disposal sites. The flowback water is at a high temperature, typically 130° F., and contains a high percentage of VOCs which vaporize and are released into the atmosphere. These vapors are toxic, create an unpleasant odor and are explosive.

### SUMMARY OF THE INVENTION

This invention resides in a system and associated methods for reducing volatile organic compounds (VOCs) which would otherwise be released during hydraulic fracturing or “fracking” operations. The system comprises an enclosed tank to receive flowback water from the operation at a level below the top of the tank, thereby creating a space in the tank above the contained water. A pump and piping are provided for routing a portion of the contained water to one or more atomizers at the top of the tank in the space above the contained water. The atomizers are operative to create a mist of very fine droplets to capture VOC vapor present in the space and return the VOCs to the water contained in the tank.

The system may further include a source of emulsifiers or other treatment chemicals added to the atomized mist to assist in capturing the VOC vapor present in the space above the contained water, and/or to coat the inner walls of the space or other surfaces to prevent volatilization from those surfaces.

In the preferred embodiment, the atomizers are rotary cage atomizers, and the emulsifiers or other treatment chemicals are mixed directly with the water routed to the atomizers. The pump used to route a portion of the contained water may be a multi-channel peristaltic pump operative to deliver the same amount of reclaimed water to each atomizer. The system may further include an oil/water separator disposed in the piping between the tank and the pump.

A method of reducing volatile organic compounds (VOCs) which would otherwise be released during hydraulic fracturing comprises the steps of receiving flowback water in a tank with a space above the water level, and pumping a portion of the water to one or more atomizers at the top of the tank in the space above the contained water. The atomizers create a mist of very fine droplets to capture VOC vapor present in the space and return the VOCs to the water contained in the tank.

The method may further include the step of mixing emulsifiers or other treatment chemicals directly with the reclaimed water in the atomizers. The same amount of reclaimed water may be delivered to each atomizer using a multi-channel peristaltic pump. The method may further include the step of separating oil from the water prior to pumping.

### BRIEF DESCRIPTION OF THE DRAWING

FIG. 1 is a diagram that shows a flowback storage tank associated with fracking operations constructed in accordance with the invention.

### DETAILED DESCRIPTION OF THE INVENTION

This invention resides in a scrubbing system and method to greatly reduce dangerous volatile organic compound (VOC) vapors released during hydraulic fracturing or so-called fracking processes. In the preferred embodiment, the water inherently created by the fracking process is used to help control the VOCs. This is important, since additional water is not only a problem to obtain, it would need to be disposed of as costly waste water.

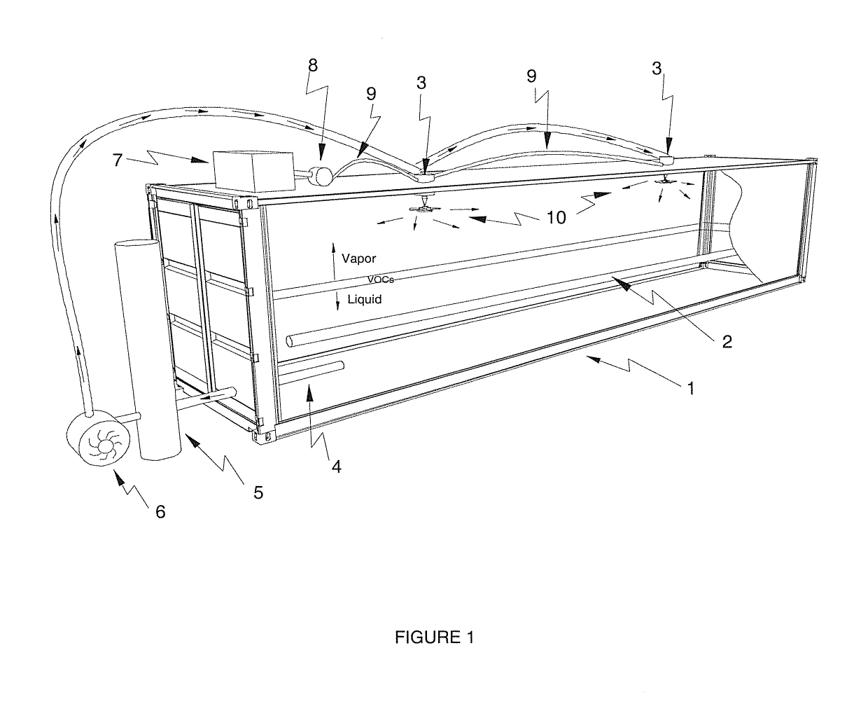

FIG. 1 is a diagram that shows a flowback storage tank associated with fracking operations. During the collection process, the water and VOCs will separate in the tank. The VOCs will rise to the top and release vapors which are typically vented to the atmosphere. To reduce these vapors, a small amount of the water from below the separated VOCs is pumped to atomization equipment above the flowback liquid. Special emulsifiers may be added to the water at the atomizer, and this water is used to create a mist of very fine droplets. The mist containing the emulsifiers is distributed throughout the space above the flowback water in the tank and on the liquid surface and walls of the tank.

The use of a rotary atomizer not only creates the mist from the inherent waste water in the flowback but also creates a turbulent flow in the vapor portion of the tank. The mixing of the mist containing the emulsifiers and the VOC vapor allows the emulsifiers to capture the VOC vapor and return it to the liquid surface. Further the use rotary atomizer allows for the mixing of concentrated emulsifiers with the recovered waste water directly in the atomizer greatly reducing the complication of the mitigation chemical delivery.

### The Process

The flowback liquid is pumped into a storage tank through diffusers where the VOCs rise to the top of the liquid. Some of the water is allowed to flow to a small setting tank or water/oil separator, where a pump will pump the water to the atomizers above the flowback liquid. This water is atomized into fine droplets and one or more special emulsifiers and other treatment chemicals are added to the atomized mist. This mist mixes with the VOC vapor and removes volatile VOCs. The mist also coats the walls and surface of the liquid to prevent volatilization from those surfaces.

### The Equipment

As shown in FIG. 1, the flowback storage tank is typically a rectangular, semi trailer sized tank (1) with approximate dimensions such as 8 ft wide, 8 ft high and 40 ft long. The flowback liquid is pumped into this tank though a large pipe (2). The portion of the pipe (2) inside the tank has many holes which act as a diffuser and minimize the mixing of the fracking flowback liquid.

One or more atomizers (3) are installed in the top of the tank to disperse the special emulsifiers and other treatment chemicals and water mist. The water for this process is removed from the bottom of the tank (4) either directly or through an oil/water separator (5). This water is pumped by a water pump (6) to the atomizer(s) where it is mixed with the concentrated treatment chemicals which are stored in a small tank (7) on the unit. These chemicals are metered by a peristaltic or similar pump (8) in small concentrated amounts directly to the atomizer.

Mixing of the water and chemicals may occur in the atomizer. This mixture is atomized and the mist (10) is allowed to fill the vapor portion of the tank. The atomizers (3) create a flow in the vapor mist mixture by the nature of the atomization process or with additional fan assistance. The level of the tank is automatically monitored to prevent the liquid from completely filling the tank.

### The Atomizers

The atomizers (3) are a key element to the success of this method. While many types of atomizers can be used, the preferred type is the rotary cage atomizer. Concentrated treatment chemical and the reclaimed water can be mixed directly in this type of atomizer, allowing the final mixture to be controlled by a small metering pump. This atomizer has a rotating basket which can create a mixing flow in the vapor as well as resist clogging from contaminates in the water. Standard hydraulic spray nozzles do not have either of these characteristics. Additionally, small fan blades may be attached to the atomizer to further mix the vapor and mist from the atomizer.

These atomizers can be driven by electric motors, hydraulic motors or even air motors depending on the availably of power sources.

### The Metering Pump

To accurately meter the correct amount of treatment chemical to the reclaimed water flow a high quality metering pump (8) is used. Several metering pump types can meet this requirement but the preferred type is the multi-channel peristaltic pump, which can deliver the exact same dose to each atomizer and can be run at very low volume rates.

### The Oil/Water Separator

Depending on the nature of the VOCs in the flowback water an oil/water separator (5) may be required. This may as simple as large diameter vertical pipe with an inlet below the surface of the flowback liquid to prevent the turbulence from the main inlet flow form introducing large amounts of VOCs to the reclaimed water. Alternatively, the oil/water separator may be a more complicated commercially available separator. The diagram shows this separator outside the main storage tank but for ease of transport and to prevent damage it cam easily be inside the tank.

1. A system for reducing volatile organic compounds (VOCs) which would otherwise be released during hydraulic fracturing, comprising:
an enclosed tank to receive flowback water from a fracking operation at a level below the top of the tank, thereby creating a space in the tank above the contained water;
a pump and piping for routing a portion of the contained water to one or more atomizers at the top of the tank in the space above the contained water; and
wherein the atomizers are operative to create a mist of very fine droplets to capture VOC vapor present in the space and return the VOCs to the water contained in the tank.

2. The system of claim 1, further including a source of emulsifiers or other treatment chemicals which are added to the atomized mist to assist in capturing the VOC vapor present in the space above the contained water.

3. The system of claim 1, further including a source of emulsifiers or other treatment chemicals which are added to the atomized mist to assist in capturing the VOC vapor present in the space and to coat the inner walls of the space and other surfaces to prevent volatilization from those surfaces.

4. The system of claim 1, wherein the atomizers are rotary cage atomizers.

5. The system of claim 1, wherein:
the atomizers are rotary cage atomizers; and
the emulsifiers or other treatment chemicals are mixed directly with the water routed to the atomizers.

6. The system of claim 1, wherein the pump used to route a portion of the contained water is a multi-channel peristaltic pump operative to deliver the same amount of reclaimed water to each atomizer.

7. The system of claim 1, further including an oil/water separator disposed in the piping between the tank and the pump.

8. The system of claim 1, wherein the tank is in the form of a semi trailer.

9. A method of reducing volatile organic compounds (VOCs) which would otherwise be released during hydraulic fracturing, comprising the steps of:
receiving flowback water in a tank with a space above the water level; and
pumping a portion of the water to one or more atomizers at the top of the tank in the space above the contained water to create a mist of very fine droplets to capture VOC vapor present in the space and return the VOCs to the water contained in the tank.

10. The method of claim 9, further including the step of adding emulsifiers or other treatment chemicals to the atomized mist to assist in capturing the VOC vapor present in the space.

11. The method of claim 9, further including the step of adding emulsifiers or other treatment chemicals to the atomized mist to assist in capturing the VOC vapor present in the space and to coats the inner walls of the space and surface of the liquid to prevent volatilization from those surfaces.

12. The method of claim 9, wherein the atomizers are rotary cage atomizers.

13. The method of claim 9, wherein:
the atomizers are rotary cage atomizers; and
including the step of mixing the emulsifiers or other treatment chemicals directly with the reclaimed water in the atomizers.

14. The method of claim 9, including the step of delivering the same amount of reclaimed water to each atomizer using a multi-channel peristaltic pump.

15. The method of claim 9, including the step of separating oil from the water prior to pumping.

16. The method of claim 9, including the step of providing a tank in the form of a semi trailer.
